(19) United States
(12) Patent Application Publication
(10) Pub. No.: US 2016/0187175 A1
(43) Pub. Date: Jun. 30, 2016

(54) Electronic device, method for calculating in-housing airflow, and computer program product

(71) Applicant: KABUSHIKI KAISHA TOSHIBA, Tokyo (JP)

(72) Inventors: Tomoyuki Suzuki, Kawasaki (JP); Tomonao Takamatsu, Kawasaki (JP); Shinya Higashi, Yokohama (JP); Kenji Hirohata, Tokyo (JP)

(21) Appl. No.: 14/757,518

(22) Filed: Dec. 23, 2015

(30) Foreign Application Priority Data
Dec. 26, 2014 (JP) 2014-266484

(51) Int. Cl. G01F 1/696; G01F 1/684

(52) U.S. Cl. CPC G01F 1/696; G01F 1/6847

(57) ABSTRACT

According to one embodiment, an electronic device includes a housing, a first heating element, a second heating element, a first sensor, a second sensor, and a calculator. The first heating element is housed in the housing. The second heating element is housed in the housing and a temporal change in amount of heat generation of the second heating element is smaller than a temporal change of the first heating element. The first sensor is housed in the housing and detects a temperature of the second heating element. The second sensor detects an ambient temperature. The calculator calculates a flow rate of airflow in the housing based on a difference between the temperature detected by the first sensor and the temperature detected by the second sensor.

### CROSS-REFERENCE TO RELATED APPLICATIONS

This application is based upon and claims the benefit of priority from Japanese Patent Application No. 2014-266484, filed Dec. 26, 2014, the entire contents of which are incorporated herein by reference.

### FIELD

Embodiments described herein relate generally to an electronic device, a method for calculating the in-housing airflow, and a computer program product.

### BACKGROUND

Typically, an electronic device is known that determines whether or not the temperature is having an adverse impact on the operating life of components.

It would be significant to be able to achieve an electronic device having a new configuration that is less inconvenient and that makes it easier to understand the time degradation of components in accordance with the thermal environment inside a housing.

### BRIEF DESCRIPTION OF THE DRAWINGS

FIG. 1 is a perspective view of an electronic device according to a first embodiment;

FIG. 2 is a planar view of an internal configuration of a housing in the electronic device according to the first embodiment;

FIG. 3 is a schematic block diagram of the electronic device according to the first embodiment;

FIG. 4 is a schematic perspective view of a configuration for detecting ambient temperature in the electronic device according to a modification example of the first embodiment;

FIG. 5 is a graph illustrating the correlation between the average heat transfer amount and the temperature in the configuration illustrated in FIG. 4;

FIG. 6 is a schematic perspective view of a configuration for detecting ambient temperature in the electronic device according to another modification example of the first embodiment;

FIG. 7 is a graph illustrating the correlation between the average heat transfer amount and the temperature in the configuration illustrated in FIG. 6;

FIG. 8 is a flowchart for explaining a sequence of operations during a calculating operation performed in the electronic device according to the first embodiment;

FIG. 9 is a schematic diagram illustrating a result of the calculating operation as output by the electronic device according to the first embodiment;

FIG. 10 is a schematic front view of an electronic device according to a second embodiment; and

FIG. 11 is a schematic planar view of an internal configuration of a housing in the electronic device according to the second embodiment.

### DETAILED DESCRIPTION

In general, according to one embodiment, an electronic device comprises a housing, a first heating element, a second heating element, a first sensor, a second sensor, and a calculator. The first heating element is housed in the housing. The second heating element is housed in the housing and a temporal change in amount of heat generation of the second heating element is smaller than a temporal change of the first heating element. The first sensor is housed in the housing and detects a temperature of the second heating element. The second sensor detects an ambient temperature. The calculator calculates a flow rate of airflow in the housing based on a difference between the temperature detected by the first sensor and the temperature detected by the second sensor.

Exemplary embodiments of the invention are described below. Herein, configurations and controls (the technical features) described in the embodiments, as well as functionality and results (the effect) achieved due to the configurations and the controls are only exemplary. Moreover, in a plurality of embodiments described below, identical constituent elements are included. Such identical constituent elements are referred to by the same reference numerals, and the relevant explanation is not repeated.

### First Embodiment

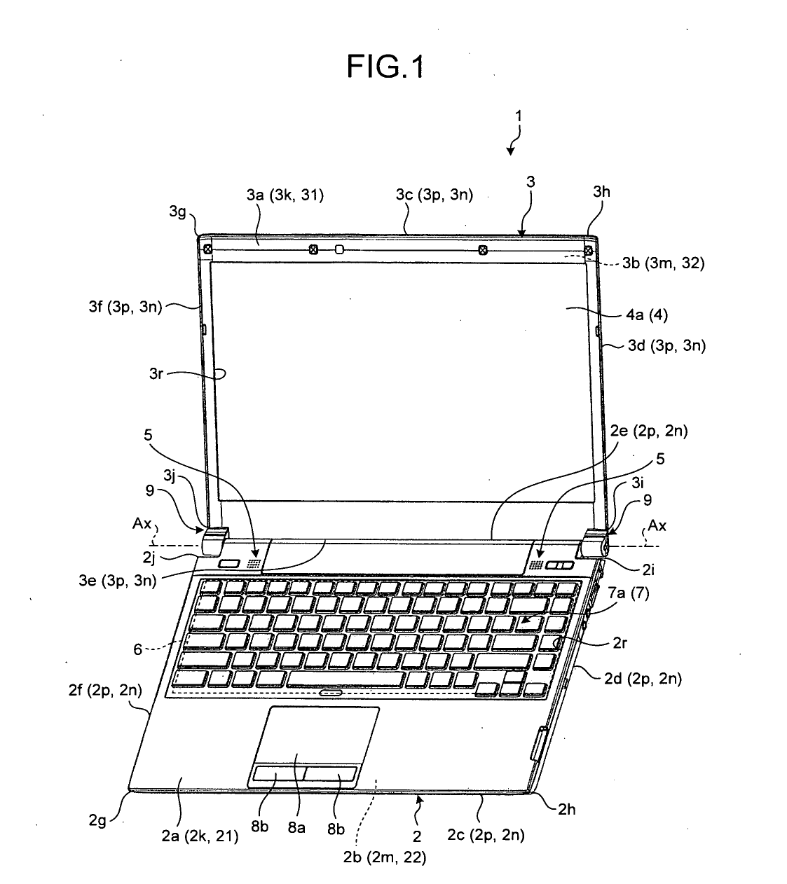

As illustrated in FIG. 1, an electronic device 1 according to a first embodiment is a clamshell personal computer. The electronic device 1 includes housings 2 and 3. The housing 2 houses a substrate 6. Moreover, the housing 2 houses input units (operating units) such as a keyboard 7, a pointing device 8a, and click buttons 8b. The housing 3 houses at least some portion of a display 4 (a display device or an output unit). Moreover, the housing 3 can have a transparent touch-sensitive panel (not illustrated) disposed in an overlapping manner on the display 4.

The housings 2 and 3 are connected in a rotatable manner via a hinge mechanism 9 (a rotation supporting unit). The electronic device 1 can be changed to any one of the following states: an open state in which the housings 2 and 3 are kept open; a folded state in which the housings 2 and 3 are folded; and a state in which the housings 2 and 3 are expanded at any angle in between the open state and the folded state. The hinge mechanism 9 connects the housings 2 and 3 in a rotatable manner around a rotary shaft Ax.

The keyboard 7, the pointing device 8a, the click buttons 8b, and a speaker 5 (a sound output unit or an output unit) are arranged in an exposed manner on a face 2a (the front face) of the housing 2. A display screen 4a of the display 4 is viewable through an opening 3r that is formed on a face 3a (the front face) of the housing 3. In the folded state, the face 2a of the housing 2 and the face 3a of the housing 3 overlap with each other in such a way that and the display screen 4a, the keyboard 7, the pointing device 8a, and the click buttons 8b are hidden by the housings 2 and 3. In the open state, the face 2a of the housing 2 and the face 3a of the housing 3 remain in an exposed condition. As a result, it becomes possible to use the keyboard 7, the pointing device 8a, the click buttons 8b, and the display screen 4a.

The housing 3 is configured to have a rectangular shape (a quadrangular shape) in the front view and the rear view. Moreover, the housing 3 is formed as a thin and flat cuboid. The housing 3 has the face 3a and has a face 3b (the rear face) that is on the opposite side of the face 3a. The faces 3a and 3b extend (expand) in the direction orthogonal to (i.e., in the direction of crossing) the thickness direction of the housing 3. Moreover, the faces 3a and 3b are substantially parallel to each other. In the front view with respect to the face 3a, the housing 3 includes four end portions 3c to 3f (peripheral portions or rim portions) and includes four corner portions 3g to 3j (apex portions or end portions). The end portions 3c and 3e are examples of long side portions, while the end portions 3d and 3f are examples of short side portions.

The housing 3 includes a wall portion 3k (the front wall portion) having the face 3a, and a wall portion 3m (the rear wall portion) having the face 3b. The wall portions 3k and 3m are rectangular (quadrangular) plate-like portions. Moreover, the housing 3 includes four wall portions 3n (side wall portions) having a face 3p (a side face or a peripheral face) cutting across the wall portions 3k and 3m. The wall portion 3k has the opening 3r formed thereon in a quadrangular shape. Thus, the wall portion 3k is a quadrangular frame-like portion. Meanwhile, a wall portion can also be referred to as a plate or a frame.

Meanwhile, the housing 3 can be configured by combining a plurality of components (divided parts). The housing 3 includes a housing member 31 (a front side member, a mask, or a front cover) that at least has the wall portion 3k, and includes a housing member 32 (a rear side member, a base, or a rear cover) that at least has the wall portion 3m. The wall portion 3n is included in at least either the housing member 31 or the housing member 32 (herein, included in the housing member 32, for example). Furthermore, the housing 3 can include another housing member (an intermediate member or a middle frame (not illustrated)) positioned in between the housing members 31 and 32. The housing 3 can be configured using a metallic material, a synthetic resin material, or the like.

The display 4 is configured to have a rectangular shape (a quadrangular shape) in the front view. Moreover, the display 4 is formed as a thin and flat cuboid. Herein, for example, the display 4 is liquid crystal display (LCD) or an organic electro-luminescent display (OELD).

The housing 2 is configured to have a rectangular shape (a quadrangular shape) in the front view and the rear view. Moreover, the housing 2 is formed as a thin and flat cuboid. The housing 2 has the face 2a and has a face 2b (the rear face) that is on the opposite side of the face 2a. The faces 2a and 2b extend (expand) in the direction orthogonal to (i.e., in the direction of crossing) the thickness direction of the housing 2. Moreover, the faces 2a and 2b are substantially parallel to each other. In the front view with respect to the face 2a, the housing 2 includes four end portions 2c to 2f (peripheral portions or rim portions) and includes four corner portions 2g to 2j (apex portions, curved portions, or end portions). The end portions 2c and 2e are examples of long side portions, while the end portions 2d and 2f are examples of short side portions.

The housing 2 includes a wall portion 2k (a front wall portion) having the face 2a, and a wall portion 2m (a rear wall portion) having the face 2b. The wall portions 2k and 2m are rectangular (quadrangular) plate-like portions. Moreover, the housing 2 includes four wall portions 2n (side wall portions) having a face 2p (a side face or a peripheral face) cutting across the wall portions 2k and 2m. The wall portion 2k has an opening 2r formed thereon in a quadrangular shape. Thus, the wall portion 2k is a quadrangular frame-like portion. Meanwhile, a wall portion can also be referred to as a plate or a frame.

Meanwhile, the housing 2 can be configured by combining a plurality of components (divided parts). The housing 2 includes a housing member 21 (a front side member, a mask, or a front cover) that at least has the wall portion 2k, and includes a housing member 22 (a rear side member, a base, or a rear cover) that at least has the wall portion 2m. The wall portion 2n is included in at least either the housing member 21 or the housing member 22 (herein, included in the housing member 22, for example). Furthermore, the housing 2 can include another housing member (an intermediate member or a middle frame (not illustrated)) positioned in between the housing members 21 and 22. The housing 2 can be configured using a metallic material, a synthetic resin material, or the like.

As illustrated in FIG. 1, inside the housing 2, one or more substrates 6 are housed on the backside of the keyboard 7. The substrate 6 is arranged in parallel to the keyboard 7. The substrate 6 is arranged at a distance from the wall portions 2k, 2m, and 2n. That is, the substrate 6 is arranged in such a way that a space (gap) is maintained between the substrate 6 and the wall portions 2k, 2m, and 2n. The substrate 6 can also be referred to as a circuit substrate, a control substrate, or a main substrate.

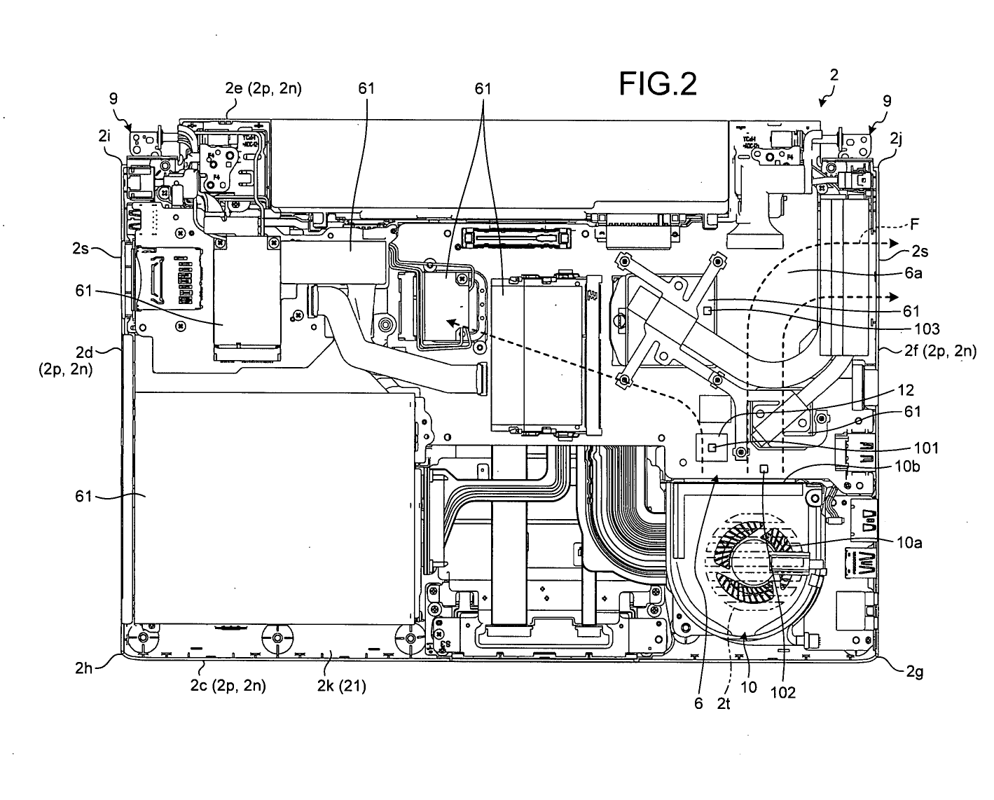

As illustrated in FIG. 2, the substrate 6 is housed in the housing 2; and on a face 6a of the substrate 6 are mounted a plurality of components 61 (electrical components) such as a central processing unit (CPU), a graphic controller, a power source circuit component, a platform controller hub (PCH), a memory slot connector, an LCD connector, an input/output (I/O) connector, a power source coil, an element, and a connector. A control circuit that is configured using the substrate 6, the components 61, and the like can include, for example, a video signal processing circuit, a tuner, a an HDMI signal processor (HDMI (registered trademark) stands for high-definition multimedia interface), an audio video (AV) input terminal, a remote-control-signal receiver, a controller, a selector, an on-screen display interface, a memory (such as a read only memory (ROM), a random access memory (RAM), a hard disk drive (HDD), or a solid state drive (SSD)), and an audio signal processing circuit. The control circuit controls the output of pictures (motion images or still images) on the display screen 4a of the display 4, controls the output of sound from a speaker (not illustrated), and controls the emission of light from a light emitting diode (LED (not illustrated)). Herein, the display 4, the speaker, and the LED are examples of an output unit.

Each component 61 is an example of a heating element (a first heating element). In order to suppress a rise in the temperature attributed to the heating of the heating elements, a fan 10 is installed in the housing 2. The fan 10 has an air inlet 10a and an exhaust outlet 10b formed therein. The air inlet 10a has an overlap with an opening 2t formed on the wall portion 2m of the housing 2. The exhaust outlet 10b opens in the space inside the housing 2. Thus, when the fan 10 is operated, the air surrounding the housing 2 (i.e., the outside air) is introduced into the housing 2 via the opening 2t overlapping with the air inlet 10a, via the air inlet 10a, and via the exhaust outlet 10b. Meanwhile, in the housing 2, on a wall portion separated from the fan 10, an opening 2s is formed for connecting the inside of the housing 2 to the outside of the housing 2. Hence, the air that is introduced by the fan 10 passes through the housing 2 and is discharged to the outside of the housing 2 via the opening 2s formed at a distance from the opening 2t. That is, in the housing 2, when the fan 10 is operated, an airflow F is generated that flows from the opening 2t, which is formed close to the fan 10, toward the opening 2s, which is formed at a distance from the fan 10. Because of the airflow F, the components 61 are cooled down. Meanwhile, in the first embodiment, the fan 10 is installed on the side from which the air is introduced into the housing 2. However, alternatively, the fan 10 can be installed on the side from which the air is discharged. In that case, the outside air (air) is introduced into the housing 2 from the opening 2s formed at a distance from the fan 10; and the fan 10 discharges the air from the inside of the housing 2 to the outside of the housing 2 via the opening 2t that is formed close to the fan 10. Thus, in the housing 2, an airflow is formed from the opening 2s toward the fan 10.

In the first embodiment, as illustrated in FIG. 2, sensors 101 and 102 are installed in the housing 2 for the purpose of detecting temperatures to be used in calculating (estimating) the flow rate of the airflow F that is formed by the fan 10.

The sensor 101 detects the temperature of a component 12, which is a different component than the components 61 that become relatively hotter. Herein, the component 12 has a smaller amount of heat generation per unit of time as compared to the components 61. That is, the component 12 has smaller temporal changes in the amount of heat generation. Moreover, the component 12 is configured to have a substantially constant amount of heat generation per unit of time. For example, the component 12 includes a resistance that is supplied with a substantially constant electrical power and a thermally-conductive member that covers the resistance. The sensor 101 is an example of a first sensor; and the component 12 is an example of a second heating element.

The sensor 102 detects the ambient temperature, which is the environmental temperature not affected by the generation of heat from the components 61 (first heating elements) in the housing 2. The ambient temperature can also be called outdoor air temperature. The sensor 102 is installed at a position that is less affected by the heat generated from the components 61. In the example illustrated in FIG. 2, the sensor 102 is installed at a position on the upstream side of the airflow as compared to the components 61 (the sensor 102 is positioned more upstream in the airflow than the components 61). That is, the sensor 102 is installed at a position closer to the exhaust outlet 10b of the fan 10 as compared to the components 61. At that position, the airflow that has not yet become hot due to the components 61 reaches the sensor 102, thereby making it easier to accurately detect the ambient temperature. Herein, the sensor 102 is an example of a second sensor.

Given below is the explanation of a method for estimating the flow rate of the airflow by referring to the temperature detection result obtained by the sensors 101 and 102. The temperature of a component i can be expressed as given below in Equation (1).

Tᵢ=QᵢRᵢ+Tₑ (1)

Herein, Tᵢ represents the temperature of the component; Qᵢ represents the amount of heat transfer; Rᵢ represents the heat resistance of the component; and Tₑ represents the ambient temperature.

In a condition in which the airflow generated due to the fan 10 is dominant, that is, in a condition in which cooling by means of forced circulation is dominant; the heat resistance Rᵢ can be expressed as given below in Equation (2).

Rᵢ=1/(hᵢ·Sᵢ) (2)

Herein, hᵢ represents the average heat transfer coefficient; and Sᵢ represents the heat-transfer area.

In the case of forced circulation, it is known that the average heat transfer coefficient is dependent on the gas velocity. For example, it is known that an average Nusselt number Nu around the rectangular column of a cross-sectionally square shape can be expressed as given below in Equation (3) using various sorts of Reynolds number Re and using coefficients A and n regarding the direction of flow.

Nu=A·Reⁿ (3)

The Nusselt number Nu is proportional to the heat transfer rate, and the Reynolds number Re is proportional to the gas velocity. Accordingly, from Equation (3), it is possible to obtain Equation (4) given below.

hᵢ∝Uⁿ (4)

Herein, U represents the gas velocity.

Thus, if the amount Qᵢ of heat transfer given in Equation (1) is assumed to be a constant number, then Equation (5) given below can be obtained from Equations (1), (2) , and (4).

ΔT=Tᵢ−Tₑ=f(U) (5)

In Equation (5), it is illustrated that a difference ΔT between the temperature Tᵢ and the ambient temperature Tₑ of the concerned component 61, for which has the amount Qᵢ of heat transfer is a constant number, becomes a function of the gas velocity U. Thus, regarding the component 61 for which the amount Qᵢ of heat transfer is a constant number, if a function ΔT=f(U) of the gas velocity U and the difference ΔT in temperatures is obtained in advance and if the correlation between the difference ΔT and the gas velocity U is obtained in advance; then the gas velocity U in the concerned component 61 can be obtained from the difference ΔT of the in-use electronic device 1 without having to install a current meter.

Meanwhile, in the housing 2, a sensor 103 is installed either in an abutting manner to each component 61 or close to each component 61. The sensor 103 detects the temperature of the corresponding component 61.

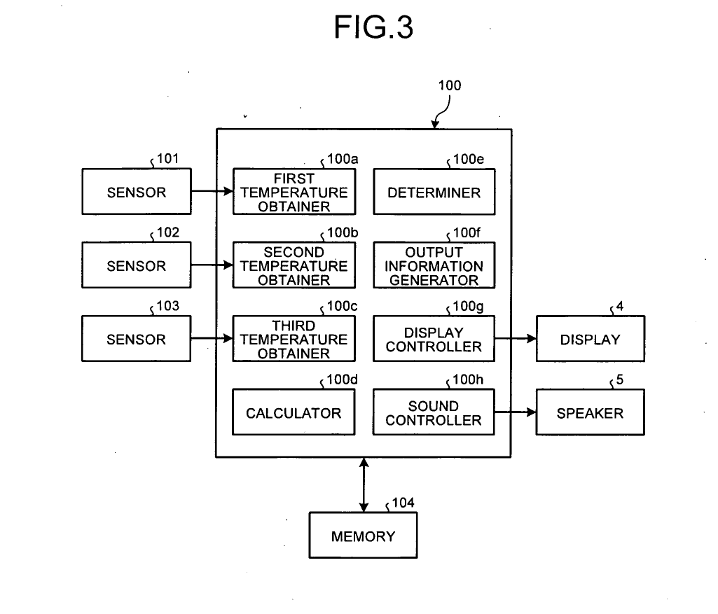

FIG. 3 is a block diagram of a controller 100 that calculates parameters based on the temperature detection result obtained by the sensors 101 and 102 as well as controls various constituent elements based on the calculated parameters. The controller 100 includes a first temperature obtainer 100a, a second temperature obtainer 100b, a third temperature obtainer 100c, a calculator 100d, a determiner 100e, an output information generator 100f, a display controller 100g, and a sound controller 100h. Herein, the controller 100 can be implemented using a CPU and the like.

The controller 100 can perform various operations according to computer programs (such as the operating system (OS) and applications) that are loaded; and can function as the first temperature obtainer 100a, the second temperature obtainer 100b, the third temperature obtainer 100c, the calculator 100d, the determiner 100e, the output information generator 100f, the display controller 100g, and the sound controller 100h. In that case, the computer programs contain modules for implementing the functions of the first temperature obtainer 100a, the second temperature obtainer 100b, the third temperature obtainer 100c, the calculator 100d, the determiner 100e, the output information generator 100f, the display controller 100g, and the sound controller 100h. Meanwhile, the computer programs can be recorded as installable or executable files in a computer-readable recording medium such as a compact disk read only memory (CD-ROM), a flexible disk (FD), a compact disk recordable (CD-R), or a digital versatile disk (DVD), thereby the computer programs can be provided. Alternatively, the computer programs can be stored in a downloadable manner in a memory of a computer connected to a communication network, thereby the computer programs can be installed. Still alternatively, the computer programs can be stored in advance in a ROM.

The first temperature obtainer 100a obtains the temperature based on the detection result obtained by the sensor 101. The second temperature obtainer 100b obtains the temperature based on the detection result obtained by the sensor 102. The third temperature obtainer 100c obtains the temperature based on the detection result obtained by the sensor 103. The calculator 100d calculates various parameters based on the obtained temperatures. The determiner 100e determines whether or not to perform a particular output based on the parameter calculation result. The output information generator 100f generates output information if it is determined to perform the particular output. The display controller 100g controls the display 4 in such a way that an image corresponding to the generated output information is displayed. The sound controller 100h controls the speaker 5 in such a way that a sound corresponding to the generated output information is output. As far as the display output is concerned, the output information generator 100f and the display controller 100g represent an example of an output controller. As far as the sound output is concerned, the output information generator 100f and the sound controller 100h represent an example of an output controller. For example, a plurality of sets of output information is stored in a memory 104. The output information generator 100f obtains, according to the flow rate of the airflow, information stored in the memory 104 in a corresponding manner to the (range of) concerned flow rate; and generates output information containing the obtained information.

In the memory 104, data indicating the correlation between the flow rate of the airflow and the temperature of the component 61 is stored in the form of a table or a map. The temperature specified in the data either can be the temperature itself, or can be data indicating the time rate of change (for example, a coefficient) of the temperature, or can be data indicating the temporal change in the temperature, or can be data indicating the attainment temperature attributed to the rise in temperature. Such data can be obtained by performing experiments or simulation, for example. Meanwhile, the memory 104 can be used to store the data of a plurality of components 61. Alternatively, the memory 104 can be used to store the data of such components 61 which have only a small margin of temperature with respect to the allowable temperature; or to store the data of such components 61 which have the highest percentage of temperature rise (the change rate); or to store the data of such components 61 which have the highest attainment temperature; or to store the data corresponding to some of the components 61 that are selected. Meanwhile, the data indicating the correlation can be in the form of a function coefficient. As far as the function is concerned, it can be written in a computer program. Moreover, as described above, the memory 104 can be used to store at least a single set of output information or to store at least a single set of information serving as the basis of the output information.

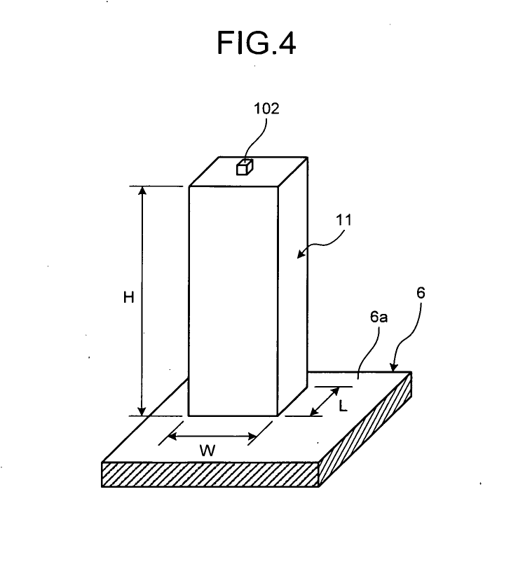

In FIG. 4 is illustrated an installation example (a modification example) of the sensor 102 used for detecting the ambient temperature. Since the sensor 102 detects the ambient temperature, it can be installed at a position separated from the components 61 representing heating elements. However, if it is difficult to secure such an installation position; then, as illustrated in FIG. 4, a heat insulating member 11 can be placed in between the portion of high temperature (in the example illustrated in FIG. 4, the face 6a of the substrate 6) and the sensor 102. With that, it becomes possible to detect the ambient temperature with more accuracy using the sensor 102.

Herein, consider a height H of the heat insulating member 11 that enables achieving the desired accuracy while substituting it for ambient temperature. As illustrated in FIG. 4, if the heat insulating member 11 is configured to have a certain prismatic cross-sectional area, then a temperature distribution θ_{H} can be expressed as Equation (6) given below.

$$\begin{matrix}{θ}_{H} = \frac{{T}_{1} - {T}_{e}}{{T}_{0} - {T}_{e}} \\ = \frac{1}{cosh ( mH )}\end{matrix} \qquad ( 6 )$$

Herein, θ_{H} represents the temperature distribution; H represents the height of the heat insulating member 11; T₁ represents the temperature at the leading portion of the heat insulating member 11; T₀ represents the temperature of the face 6a of the substrate 6; and Tₑ represents the ambient temperature. Moreover, m can be expressed as Equation (7) given below.

$$m = \sqrt{\frac{2 {h}_{i} ( W + L )}{λ \cdot W \cdot L}} \qquad ( 7 )$$

Herein, W represents the cross-sectional width of the heat insulating member 11; L represents the cross-sectional length of the heat insulating member 11; and λ represents the heat transfer coefficient of the heat insulating member 11.

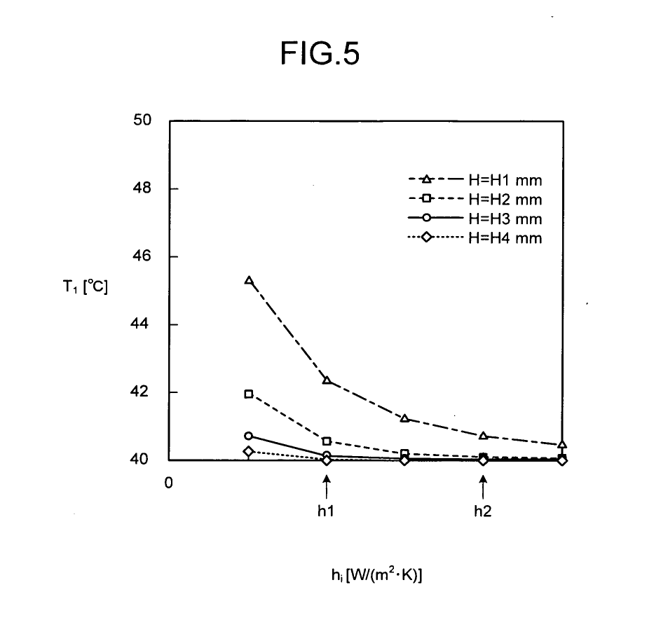

In FIG. 5 are illustrated examples of the calculation result obtained according to Equation (6) and used to determine the specifications of the heat insulating member 11. In FIG. 5 are illustrated examples of the correlation between the average heat transfer coefficient hᵢ and the temperature T₁, which is detected by the sensor 102, in the case in which the temperature on the face 6a of the substrate 6 and the cross-sectional width W and the cross-sectional length L of the heat insulating member 11 are fixed to particular values and the height H (see FIG. 4) is varied from a height H1 to a height H4. Such correlation can be obtained by performing experiments or simulation, for example. In the normal usage state of the electronic device 1, if it is known that the average heat transfer coefficient hᵢ is, for example, within the range from h1 to h2 illustrated in FIG. 5; then it can be understood from FIG. 5 that a heat shielding effect using the heat insulating member 11 can be achieved if the height H of the heat insulating member 11 is within the heights H2 to H4. Moreover, in such a case, within the range of heights from the height H2 to the height H4 in which the heat shielding effect satisfies particular conditions, the lowest height H2 can be selected as the height H of the heat insulating member 11.

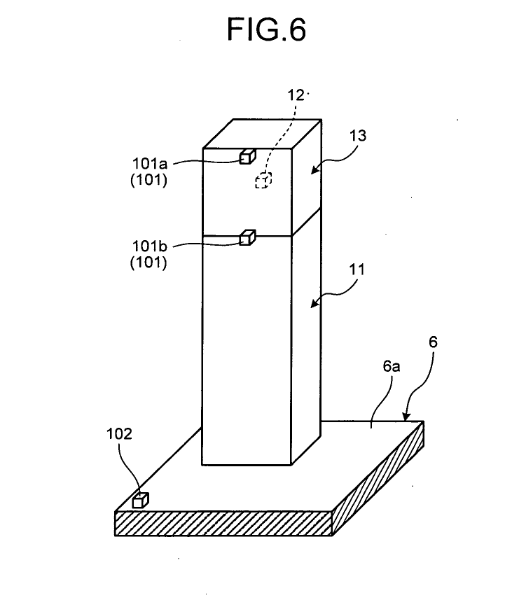

In FIG. 6 is illustrated an installation example (a modification example) of the sensor 101 used for detecting the temperature of the component 12 and the sensor 102 used for detecting the ambient temperature. As illustrated in FIG. 6, on the face 6a of the substrate 6, the component 12 representing a second heating element and a thermally-conductive member 13 that houses the component 12 are installed via the heat insulating member 11. The thermally-conductive member 13 is made of a metallic material, for example. More specifically, for example, after the component 12 is housed in a hole formed in the thermally-conductive member 13, the hole is covered or filled, and the configuration illustrated in FIG. 6 is achieved. A sensor 101a is installed in the leading portion of the thermally-conductive member 13, while a sensor 101b is installed in the boundary portion between the heat insulating member 11 and the thermally-conductive member 13. As far as the sensor 101 is concerned, either one of the sensors 101a and 101b can be installed. In between the sensors 101 and 102 is placed the heat insulating member 11 having the specifications that enable heat shielding against the heat generated from the component 12. Hence, the detection result obtained by the sensor 102 is insusceptible to the heat generated from the component 12.

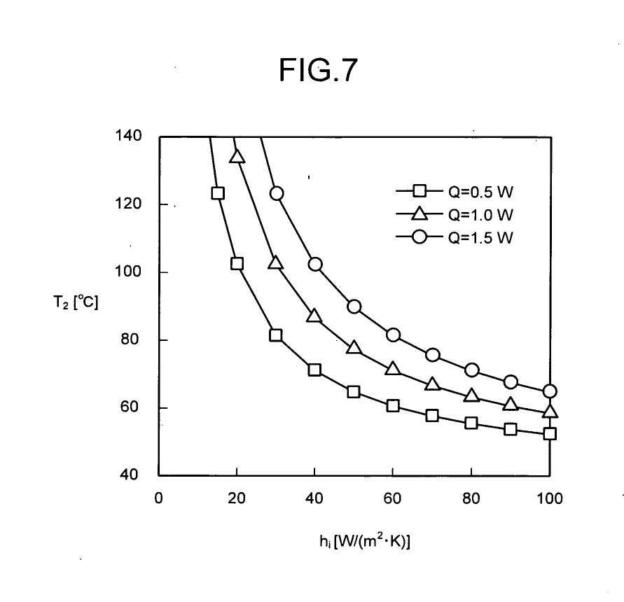

In FIG. 7 are illustrated detection results of a temperature T₂ detected by the sensor 101b in the case in which the ambient temperature is constant at 40° C., the temperature detected by the sensor 101a is constant at 60° C., and the amount of heat transfer (the amount of heat generation) from the component 12 is varied to three values. As an example, assume that the amount Qᵢ of heat transfer from the component 12 is set to 0.5 W. In that case, smaller the average heat transfer coefficient than 50 W/(m²·K), the more drastic becomes the rise in the temperature T₂ detected by the sensor 101b. In such a case, if a constant heating element is disposed at a location having the average heat transfer coefficient of about 50 W/(m²·K) during normal time, the change in air volume can be more accurately detected as the change in temperature. In such a configuration, from among the dimension of the thermally-conductive member 13, the amount of heat generation from the component 12, and the position of the component 12; if any two values are set, then the remaining value can be set in such a way that a more appropriate result is obtained.

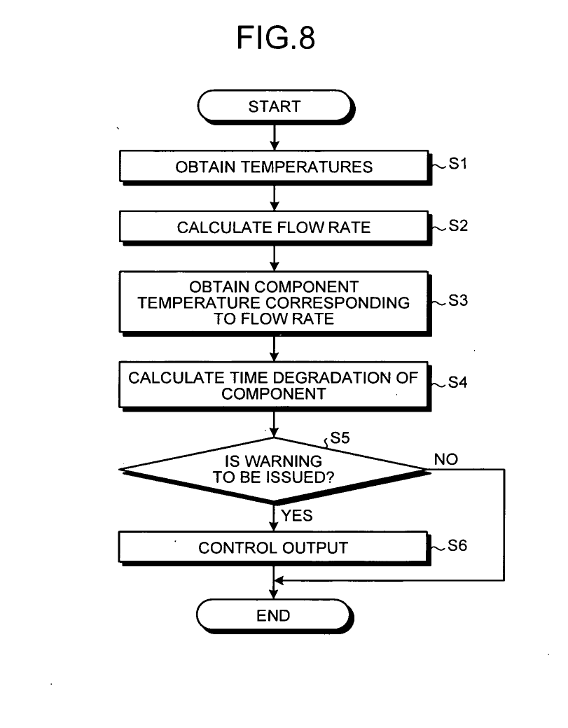

In FIG. 8 is illustrated calculation for the flow rate of the airflow and an example of a calculating operation performed based on the value of the calculated flow rate. Firstly, the first temperature obtainer 100a obtains the temperature of the component 12 by referring to the detection result of the sensor 101; the second temperature obtainer 100b obtains the ambient temperature by referring to the detection result of the sensor 102; and the third temperature obtainer 100c obtains the temperature of the component 61 by referring to the detection result of the sensor 103 (S1). Then, the calculator 100d calculates the flow rate of the airflow according to the method described earlier and based on the temperature of the component 12 and the ambient temperature (S2).

Subsequently, from the data stored in the memory 104 and the functions written in computer programs, the calculator 100d obtains, based on a function or data (for example, a table or a map) indicating the correlation between the flow rate of the airflow and the rise in temperature in each component 61, the data about the temperature of the concerned component 61 corresponding to the flow rate of the airflow calculated at S2 (S3). Herein, at S3, it is not necessary to obtain the temperatures of all components 61. Instead, the temperatures of following types of components 61 can be obtained: the components 61 having only a small margin of temperature with respect to the allowable temperature; or the components 61 having the highest percentage of temperature rise (the change rate); or the components 61 having the highest attainment temperature; or some of the components 61 that are selected. Moreover, at S3, it is also possible to calculate the time rate of change of the temperature, the temporal changes in the temperature from the current timing onward, and the maximum attainment temperature estimated subsequently. Furthermore, in the calculations performed at S3, the temperature of the components 61 obtained at S1 can be compared, and the rise in temperatures attributed to the load of operations of the components 61 can be calculated separately from the rise in temperatures attributed to the decline, in the flow rate of the airflow. As a result, the rise in temperatures attributed to an increase in a temporary calculation load of the electronic device 1 can be excluded from being considered as a factor for estimating the degradation of the components 61. Meanwhile, if the rise in temperature attributed to an increase in the calculation load proceeds beyond a certain period of time, then the rise in temperature can be included as a degradation factor.

Subsequently, based on the temperature of the component 61 as calculated at S3, that is, based on the change in the temperature corresponding to the change in the flow rate of the airflow; the calculator 100d calculates the time degradation of the concerned component 61 (S4). For example, at S4, a degradation parameter indicating the time degradation is set in such a way that higher the value of the degradation parameter, greater is the degree of degradation. The operating life is indicated by setting a particular value (such as 100). Meanwhile, the degradation parameter can go on decreasing as time proceeds. Then, by performing experiments or simulation with respect to the component 61, the inclination (the time rate of change) of the degradation parameter corresponding to the temperature is obtained in advance, and the inclination is stored in the memory 104. The calculator 100d can refer to the memory 104 and obtain the inclination of the degradation parameter corresponding to the temperature calculated at S3, and can calculate the cumulative value of the degradation parameter of the concerned component 61. Meanwhile, the rate of change for the inclination of the degradation parameter with respect to the temperature can be set for each component 61. More specifically, for example, if it is found that the temperature is higher than normal by 5° C. due to a decline in the flow rate of the airflow, then the calculator 100d can change the inclination (the time rate of change) of the degradation parameter by 1.5 times. Moreover, if it is found that the temperature is higher than normal by 10° C., then the calculator 100d can double the inclination of the degradation parameter.

Then, based on the calculation result obtained at S4, the determiner 100e determines whether or not to output the output information (S5). A threshold value of the change in the inclination of the degradation parameter corresponding to the component 61 is stored in the memory 104. Thus, at S5, the determiner 100e compares the change in the inclination of the degradation parameter with the threshold value, and determines whether or not to output the output information.

If it is determined to output the output information (Yes at S5), the output information generator 100f generates output information, and the display controller 100g controls the display 4 in such a way that the output information is displayed. Moreover, the sound controller 100h can control the speaker 5 in such a way that the output information is output as sound (S6). Herein, the output information represents information corresponding to the airflow of the air inside the housing 2. More specifically, for example, the output information represents information for presenting the status of the airflow such as the quality, the extent, and the numerical value of the airflow; or information for prompting improvement in the status of the airflow; or information for prompting elimination of the obstacle factors regarding the airflow; or information for issuing a warning. Meanwhile, if it is determined not to output the output information (No at S5), then output information is not output.

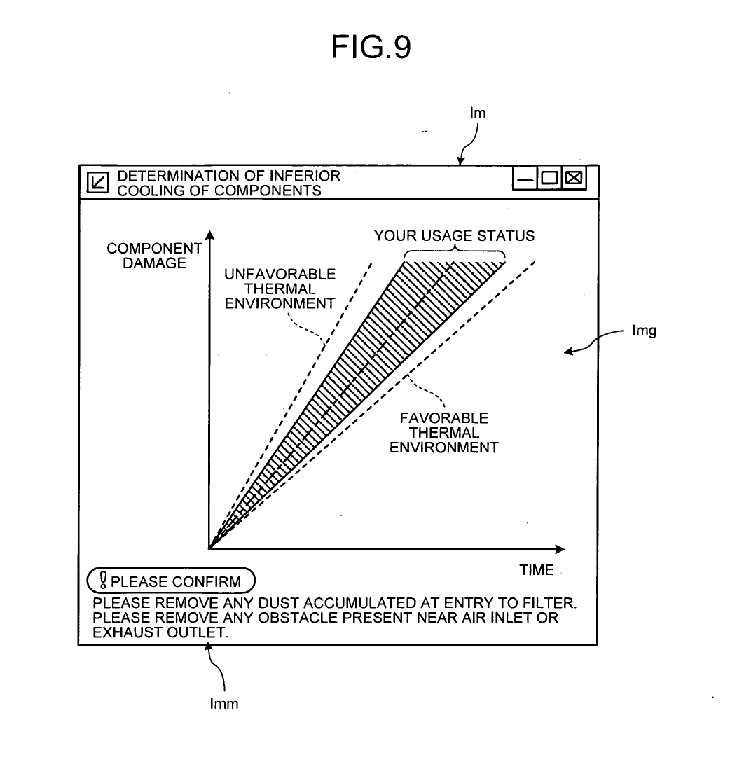

In FIG. 9 is illustrated an image Im corresponding to the output information displayed on the display 4 at S6. The image Im includes a graph Img indicating time degradation and a message Imm made of character information.

In the graph Img, the horizontal axis represents time and the vertical axis represents component damage (the degradation parameter). Along with a few reference lines, the graph Img indicates the status of the existing time degradation. The reference lines include the temporal degradation of the degradation parameter in the case of having a favorable thermal environment and the temporal degradation of the degradation parameter in the case of having an unfavorable thermal environment. While creating the reference lines, a plurality of experiment results or simulation results having different thermal environments (different flow rates of the airflow) are obtained. The reference line in the case of a favorable thermal environment represents the median+2σ in a plurality of experiment results or simulation results. The reference line in the case of an unfavorable thermal environment represents the median−2σ in a plurality of experiment results or simulation results. The status of the time degradation in the existing thermal environment represents the hatched area having “your usage status” written therein, and the line in the center represents the degradation parameter calculated at S4. Meanwhile, in FIG. 9, schematically, it is illustrated that the degradation parameter represents a straight line. However, in reality, the degradation parameter can also represent a bent line.

The message Imm specifies the factors estimated to have caused a decline in the flow rate of the airflow (conduction obstacle) and prompts elimination of the obstacle factors for the airflow. As a result, if any dust is accumulated at the entry to the filter, the user can remove the dust. Alternatively, if the air inlet and the exhaust outlet of the housing 2 are covered by some object, then the user can take care of the situation (the obstacle factor).

As described above, in the first embodiment, the calculator 100d calculates the flow rate of the airflow inside the housing 2 based on the temperature of the component 12, which has smaller temporal changes in the amount of heat generation as compared to the components 61 (a temporal change in the amount of heat generation of the component 12 is smaller than a temporal change of the component 61), and based on the ambient temperature. As a result, the flow rate of the airflow inside the housing 2 can be detected without having to install a current meter. Moreover, when there is a rise in the temperatures of the components 61, it is possible to detect the degree of impact (the ratio) of the rise in temperature attributed to the decline in the flow rate of the airflow inside the housing 2. Hence, for example, the estimation of time degradation of the components can be performed with more accuracy. Moreover, if the detection result of the rotating velocity of the fan is also taken into account, then it becomes possible to distinguish whether the decline in the airflow is attributed to the decline in the rotating velocity of the fan or attributed to some other factor (such as filter clogging or an obstacle). Hence, for example, when there is conduction obstacle in the airflow due to a decline in the performance of the fan, or due to filter clogging, or due to an obstacle; it becomes possible not only to identify the conduction obstacle in the airflow and to identify the mode of the conduction obstacle (the failure mode) but also to notify the user about the corresponding factors (the estimated factors). Furthermore, if some other detection result other than the rotating velocity of the fan is taken into account, then the degree of impact (the ratio) attributed to some other event can be calculated.

Moreover, in the first embodiment, the sensor 102 (a second sensor) for detecting the ambient temperature is positioned on the upstream side of the airflow as compared to the components 61 (first heating elements). Hence, for example, the detection of temperature done by the sensor 102 becomes insusceptible to the heat generated from the components 61.

Furthermore, in the first embodiment, since the sensor 102 (a second sensor) is installed in the housing 2; the ambient temperature can be detected using a simpler configuration, for example.

Moreover, according to a modification example of the first embodiment, the heat insulating member 11 (a first heat insulating member) is disposed on the substrate 6 (a circuit substrate), and the sensor 102 (a second sensor) is disposed on that side of the heat insulating member 11 which is opposite to the substrate 6. As a result, there is an increase in the positions at which the sensor 102 can be installed for detecting the ambient temperature in the housing 2.

Furthermore, according to another modification example of the first embodiment, the sensor 102 (a second sensor) is installed on the substrate 6 (a circuit substrate); the heat insulating member 11 (a second heat insulating member) is disposed on the substrate 6; and the component 12 (a second heating element) is disposed on that side of the heat insulating member 11 which is opposite to the substrate 6. Hence, the detection of temperature done by the sensor 102 becomes insusceptible to the heat generated from the component 12.

Moreover, in the first embodiment, the amount of heat generation from the component 12 (a second heating element) has substantially constant temporal changes. Hence, it becomes easier to enhance the accuracy of estimating the flow rate of the airflow using the detected temperature.

Furthermore, in the first embodiment, the component 12 (a second heating element) is a resistance, thereby making it easier to have a simpler configuration of the component 12.

Moreover, in the first embodiment, the sensor 103 (a third sensor) is installed for detecting the temperature of the component 61 (a first heating element). Hence, it can be distinguished and detected whether a rise in the temperature of the component 61 is attributed to the heat generated due to the calculation load or attributed to a decline in the flow rate of the airflow, that is, attributed to inferior cooling. Hence, for example, the time degradation of the components 61 can be estimated with more accuracy.

Furthermore, in the first embodiment, the electronic device 1 includes the fan 10, the components 61, the sensor 101, and the display 4 (an output unit) that is used to output the image Im (information) indicating the time degradation of the components 61 in accordance with the cooling performance of the fan 10. Thus, the user can get to know about the time degradation of the components 61 in accordance with the cooling performance of the fan 10.

### Second Embodiment

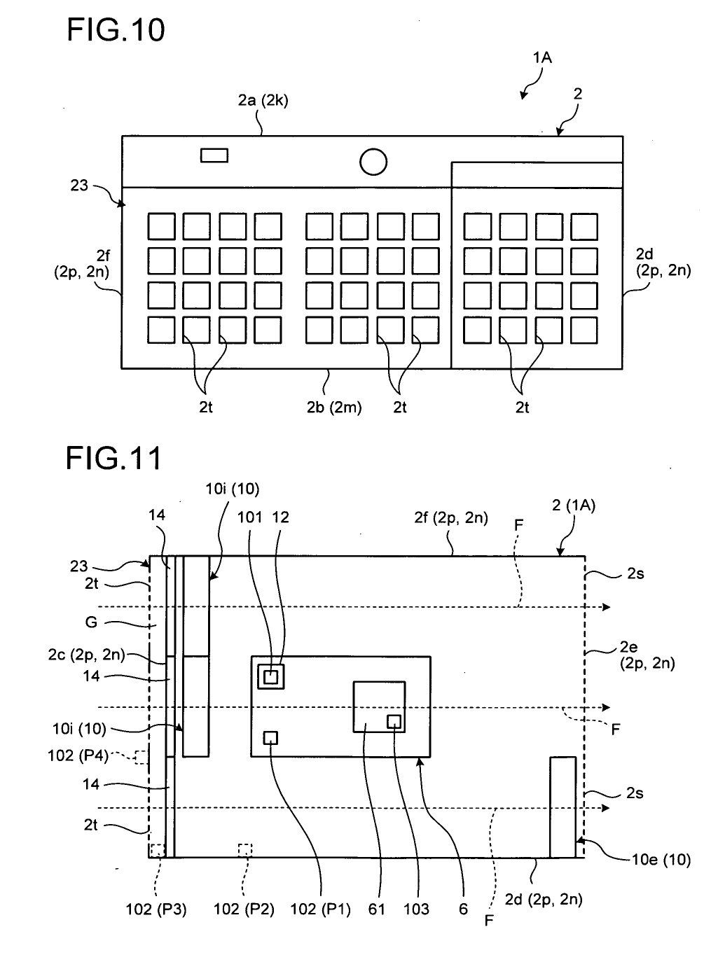

As illustrated in FIGS. 10 and 11, an electronic device 1A according to a second embodiment is a server device. The electronic device 1A includes the housing 2 that is a flat cuboid. In the second embodiment too, the housing 2 of the electronic device 1A houses the substrate 6 on which the component 61 (a first heating element) and the component 12 (a second heating element) are installed. Moreover, the sensor 103 (a third sensor) is installed on the component 61, and the sensor 101 (a first sensor) is installed on the component 12. The sensor 102 (a second sensor) is installed at a position that is less affected by the heat generated from the components 12 and 61. More particularly, for example, aside from installing the sensor 102 at a position P1 on the substrate 6 in an identical manner to the first embodiment, the sensor 102 can alternatively be installed at a position P2 that is inside the housing 2 and that abuts against the inside of the wall portion 2n of the housing 2, or at a position P3 on a cover member 23 (an external cover) that covers the housing 2 with a gap G therebetween (i.e., the position P3 in the gap G), or a position P4 on the outside of the housing 2. Meanwhile, the position P2 can alternatively be on the inside of a wall portion other than the wall portion 2n.

In the housing 2, on the cover member 23 that covers the wall portion 2n illustrated on the left side in FIG. 11 (i.e., on the side of the end portion 2c), the opening 2t is formed that functions as the air inlet for taking in the air from the outside of the housing 2 to the inside of the housing 2. Moreover, on the wall portion 2n illustrated on the opposite side, that is, on the right side in FIG. 11, the opening 2s is formed that functions as the exhaust outlet for discharging the air from the inside of the housing 2 to the outside of the housing 2. Herein, the cover member 23 is disposed on the housing 2 in a detachably-attachable manner.

Moreover, in the second embodiment, a plurality of (three) fans 10 is installed in the housing 2 for the purpose of generating airflow. Of those fans 10, a fan 10i is positioned in the vicinity of the opening 2t serving as the air inlet; while a fan 10e is positioned in the vicinity of the opening 2s serving as the exhaust outlet. The fan 10i is an example of an intake fan, and the fan 10e is an example of an exhaust fan.

In the vicinity of the opening 2t is disposed a filter 14. The fan 10i and the filter 14 are designed in a detachably-attachable manner provided the cover member 23 is detached. That makes it easier for the user to do maintenance of the fan 10i and the filter 14.

With such a configuration according to the second embodiment, in the housing 2, the airflow F is generated that flows from the opening 2t toward the opening 2s. In the second embodiment too, the sensors 101 and 102 are installed at a distance from the component 61 representing a first heating element, and are installed on the upstream side of the airflow F as compared to the component 61. Moreover, the sensor 101 is disposed in an abutting manner to the component 12 representing a second heating element. Even with such a configuration according to the second embodiment, it is possible to achieve the same behavior and the same effect as the first embodiment. Meanwhile, in the housing 2, it is also possible to dispose a plurality of sets of the component 12 (a second heating element) and the sensor 101 corresponding to the component 12. Furthermore, the calculation result obtained by the calculator 100 based on the detection result of the sensors 101 to 103 can be used as part of the reliability availability and serviceability (RAS) function. Moreover, it goes without saying the configurations according to the modification examples of the first embodiment as illustrated in FIGS. 4 and 6 can be implemented in the second embodiment too.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### APPENDIX

An electronic device comprising: a housing; a component installed in the housing; a temperature sensor installed in the housing; and an output unit that outputs information indicating time degradation of the component occurring according to thermal environment inside the housing.

What is claimed is:

1. An electronic device comprising:
a housing;
a first heating element housed in the housing;
a second heating element housed in the housing, a temporal change in amount of heat generation of the second heating element being smaller than a temporal change of the first heating element;
a first sensor housed in the housing, the first sensor detecting a temperature of the second heating element;
a second sensor that detects an ambient temperature; and
a calculator that calculates a flow rate of airflow in the housing based on a difference between the temperature detected by the first sensor and the temperature detected by the second sensor.

2. The electronic device according to claim 1, wherein the second sensor is positioned more upstream in the airflow than the first heating element.

3. The electronic device according to claim 1, wherein the second sensor is installed in the housing.

4. The electronic device according to claim 1, further comprising:
a circuit substrate housed in the housing; and
a first heat insulating member disposed on the circuit substrate, the first heat insulating member suppressing heat transfer, wherein
the second sensor is disposed on a side of the first heat insulating member which is opposite to the circuit substrate.

5. The electronic device according to claim 1, further comprising:
a circuit substrate housed in the housing; and
a second heat insulating member disposed on the circuit substrate, the second heat insulating member suppressing heat transfer, wherein
the second heating element is disposed on a side of the second heat insulating member which is opposite to the circuit substrate.

6. The electronic device according to claim 1, wherein the temporal change in amount of heat generation of the second heating element is substantially constant.

7. The electronic device according to claim 1, wherein the second heating element is a resistance.

8. The electronic device according to claim 1, further comprising a third sensor that detects a temperature of the first heating element.

9. The electronic device according to claim 1, further comprising an output controller that controls an output unit to output information according to a calculation result obtained regarding the flow rate by the calculator.

10. The electronic device according to claim 9, wherein the information according to a calculation result of the flow rate represents information for prompting elimination of an obstacle factor for airflow.

11. A method for calculating in-housing airflow, executed by an electronic device, the method comprising:
detecting a temperature of a second heating element housed in a housing, a temporal change in amount of heat generation of the second heating element being smaller than a temporal change of a first heating element housed in the housing;
detecting an ambient temperature; and
calculating a flow rate of airflow in the housing based on difference between the temperature of the second heating element and the ambient temperature.

12. A computer program product including programmed instructions embodied in and stored on a non-transitory computer readable medium, wherein the instructions, when executed by a computer, cause the computer to perform:
detecting a temperature of a second heating element housed in a housing, a temporal change in amount of heat generation of the second heating element being smaller than a temporal change of a first heating element housed in the housing;
detecting an ambient temperature; and
calculating a flow rate of airflow in the housing based on difference between the temperature of the second heating element and the ambient temperature.
